(19) United States
(12) Patent Application Publication
(10) Pub. No.: US 2022/0269994 A1
(43) Pub. Date: Aug. 25, 2022

(54) SYSTEM AND METHOD FOR AUTOMATED CREATION OF A TIME SERIES ARTIFICIAL INTELLIGENCE MODEL

(71) Applicant: Averroes.ai Inc., San Mateo, CA (US)

(72) Inventors: Omar Altamimi, Amman (JO); Tareq AlJaber, Brentwood, CA (US); Aisha Al-Sadi, Irbid (JO)

(21) Appl. No.: 17/678,294

(22) Filed: Feb. 23, 2022

Related U.S. Application Data
(60) Provisional application No. 63/152,622, filed on Feb. 23, 2021.

(51) Int. Cl. G06N 20/20; G06N 7/00; G06N 5/04; G06K 9/62; G06F 8/41

(52) U.S. Cl. CPC G06N 20/20; G06N 7/005; G06N 5/04; G06K 9/6227; G06K 9/6265; G06F 8/437

(57) ABSTRACT

A system and method that facilitate the processing, analysis, modeling, and model deployment for AI applications using time series data. This system enables clients with no prior knowledge in coding to obtain descriptive and predictive outputs which provide a more profound understanding of the modelled system and produce actionable insights. These models are deployed through containerized cloud-based systems such that predictions are obtained via a single Web API call. Through the automated process of the invented Ai abstraction engine, clients can create Forecasting, Regression, and Classification applications as well as specific Predictive Maintenance Models. The predicted outputs of these models are fed to an explainability function that returns the inputs with highest contribution to the prediction, which consequently ensures a high measure of confidence and allows for reasoning.

### CROSS-REFERENCE TO RELATED APPLICATIONS

This application claims priority to a U.S. provisional patent application Ser. No. 63/152,622 filed on Feb. 23, 2021, which is incorporated herein by reference to its entirety.

### FIELD OF INVENTION

The present invention relates to a system and method for creating an artificial intelligence model, and more particularly, the present invention relates to an artificial intelligence abstract engine for time series data that can automate and accelerate the process of creating an artificial intelligence model to solve time series tasks.

### BACKGROUND

Implementations of artificial intelligence are being adopted in almost every sector. With the primary objective to make life easier and perform complex tasks, AI has become the next big thing. The implementation of AI can be seen in common household utilities, smartphones, businesses, research, and almost every field. With AI, the machines have become intelligent that could learn and make decisions.

For building an AI system, prior knowledge and certain skills are mandatory that come from learning and experience. Besides the widespread use and increasing demand for AI in various sectors, the required expertise and time for building an AI system is a major roadblock in the widespread adoption of AI. Moreover, the incorporation of AI can make the process costlier and beyond the budget for many.

The Internet of things (IoT) is also being adapted in different sectors for connecting and exchanging data with other devices and systems over the Internet. The embedded sensors in the IoT devices generates a lot of data that describes the network of physical objects, “things”, that are embedded with sensors, software, and other technologies for the purpose of connecting and exchanging data with other devices and systems over the Internet. As the world is rapidly deploying more and more sensors, there is more and more data being generated.

The real value that the Internet of Things creates is at the intersection of gathering data and leveraging it. Analysis of large amount of data generated by the sensors require costly resources. The manufacturing operations, for example, are inundated with data and struggle to manage the data flow and extract useful, actionable information from the data. Companies are turning to AI solutions to manage the ever-expanding volumes of data. The creation and deployment of AI solutions is costly and time consuming. The resources required to design and implement an AI solution cannot cope with the rapidly increasing demand. It may take about 4 to 6 months to implement one AI application. The AI data scientist availability is scarce which increase the cost of building an AI solution by several times.

Thus, a need is appreciated for an infrastructure that can generate ready-to-use or customizable AI systems, models, programs, and the like. A need is there for an infrastructure that can generate models that can be embedded or incorporated in existing projects for Al functionality.

The term “user” hereinafter refers to a person who uses or can use a service. Users of computer systems and software products may not need to understand the technology behind the computer systems and software products.

The term “client” herein refers to a receiving end of a service or the requester of the service in a client/server model type of system. The client is most often located on another system or computer, which can be accessed via a network.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

To mitigate the challenges of cost, schedule, and the limited availability of data scientists, the principal object of the present invention is directed to a system and method for automated creation of AI models.

It is another object of the present invention to automate most steps involved in the analysis, processing, and model fitting, thus enabling users or clients with little to no coding knowledge or data science experience to readily create effective Time Series deep learning models.

It is another object of the present invention that incorporating AI in projects is cost effective.

It is still another object of the present invention that AI models can be quickly created.

It is a further object of the present invention that the use of AI in various sectors can be increased.

In one aspect, disclosed is an artificial intelligence abstract engine for time series data that can automate and accelerate the process of creating artificial intelligence models. The disclosed system and method allows for creation of forecasting, regression, and classification models as well as specific predictive maintenance models.

In one aspect, the disclosed system and method can provide for modelling of any time series problem and ability to do an auto quality filling to the noisy series which is always the main problem to effectively use AI with time series data. General auto deep learning for time series to find the best pipeline (models, normalization, encoding . . . etc.) for each pair of (problem-data). General real time streaming for integrating live sensors to the chosen best model. All these modules can be put together in an intuitive UX process to make the full flow easier for any non-data scientist to auto generate an AI time series model and deploy it in production.

In one aspect, disclosed is a system and method that facilitate the processing, analysis, modeling, and model deployment for AI applications using time series data. This system enables clients with no prior knowledge in coding to obtain descriptive and predictive outputs which provide a more profound understanding of the modelled system and produce actionable insights. These models are deployed through containerized cloud-based systems such that predictions are obtained via a single Web API call. Through the automated process of the disclosed AI abstraction engine, clients can create Forecasting, Regression, and Classification applications as well as specific Predictive Maintenance Models. The predicted outputs of these models are fed to an explainability function that returns the inputs with highest contribution to the prediction, which consequently ensures a high measure of confidence and allows for reasoning.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram illustrating an architecture of the disclosed system, according to an exemplary embodiment of the present invention.

FIG. 2 is a flowchart illustrating the creation of an AI model by the disclosed system, according to an exemplary embodiment of the present invention.

FIG. 3 is a flow chart illustrating a dynamic auto processing pipeline (DAPP) module of the system, according to an exemplary embodiment of the present invention.

FIG. 4 is a flowchart illustrating an operation of an AI model created by the disclosed system, according to an exemplary embodiment of the present invention.

FIG. 5 is a flowchart illustrating an operation of an AI model created by the disclosed system, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Time series data, hereinafter, refers to a collection of observations obtained through repeated measurements over time. In a plot of time series data on a graph, one of the axes is time. As our world gets increasingly instrumented, sensors and machines are constantly emitting a relentless stream of time series data. In brief, the time series data is a one-dimensional labeled array capable of holding data of any type (integer, string, float).

Disclosed is a system and method for creating artificial intelligence models that can be incorporated in various projects for integrating artificial intelligence capabilities. The disclosed system and method can make the process of creating AI models quicker and cost effective. Professionals without expert knowledge in creating AI models will be able to create and incorporate AI models in their projects. The disclosed system and method can automate most of the steps in building an AI model with high accuracy and robust results. For example, IoT solutions and AI solutions can combine to gain significant advantage. The various existing limitations in adoption of AI technology by organizations and individuals can be overcome by reducing the cost of development and implementation, decreasing the development durations, and reducing the need of data scientists.

The Internet of things (IoT) describes the network of physical objects—“things”—that are embedded with sensors, software, and other technologies for the purpose of connecting and exchanging data with other devices and systems over the Internet. The Internet of Things really comes together with the connection of sensors and machines. That is to say, the real value that the Internet of Things creates is at the intersection of gathering data and leveraging it. All the information gathered by all the sensors in the world is not worth if there is not infrastructure in place to analyze it in real time.

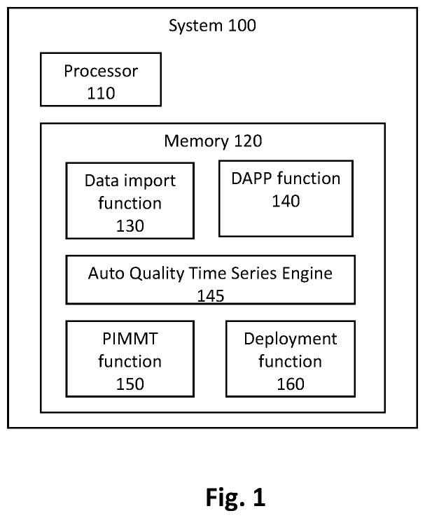

Referring to FIG. 1, which shows an environmental architecture of the disclosed system 100, also referred to herein as Time Series Generalization Engine (TSG Engine), or simply an engine. The system 100 can include a processor 110 and a memory 120 coupled to each other. The processor 110 can be any logic circuitry that responds to, and processes instructions fetched from the memory 120. The memory 120 may include one or more memory chips capable of storing data and allowing any storage location to be directly accessed by the processor. The memory can include four major functions i.e., the data import function 130, a pre-processing function or Dynamic Auto Processing Pipeline (DAPP) 140, an auto quality time series engine 145, a model building function (PIMMT) 150, and a deployment function 160, which includes prediction and explainability. The term “function”, “modules”, “code”, “model” and the like refers to a set of instruction, code, software, and the like which upon execution by the processor performs one or more steps of the disclosed methodology.

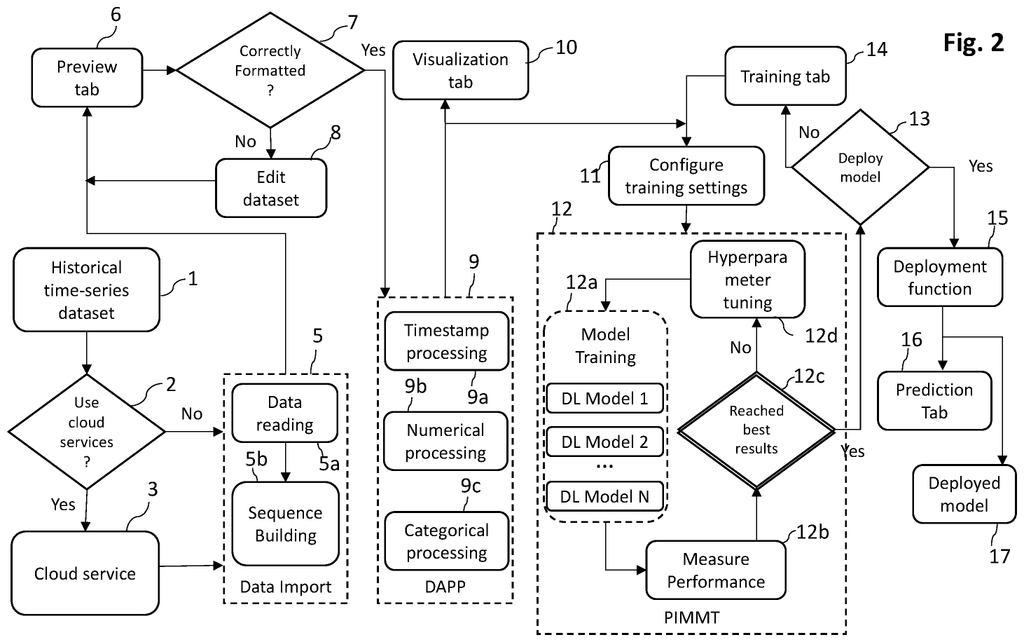

Referring to FIG. 2 which is a flow chart illustrating an exemplary embodiment of disclosed methodology that can be implemented in the environment of the disclosed system 100. The inputs that can be taken by the disclosed system for creating AI models can be files containing time-series datasets 1, and the output of the disclosed system can be an AI model 17 trained to analyze a specific dataset.

The data import function 130 can be executed to read the data from the client's available historical time series dataset 1. A decision 2 can be made by the client whether or not to access a dataset using a cloud service provider 3 or have files loaded manually to the Data Import block 5. The disclosed system can ingest data in any one of multiple data formats including, for example, csv, tsv, json, txt, xls, xlsx, and the like file formats. Once ingested into the Data Import block 5, first the data can undergo a data reading function 5a and then a sequence building function 5b. The sequence building function can convert time series two-dimensional data to three dimensional data holding the temporal context by making each row (sample, features) hold the information about previous rows “lookback” period so that the data will be converted to each row (sample, lookback time stamps, features). In the data reading function 5a, the data can be formatted to DataFrames, wherein the DataFrames can be the data structures that contain data organized in two dimensions i.e., rows and columns, with labels that correspond to the rows and columns, and then generated in time series data generators to include the temporal context of signals; each time stamp can contain a signal of lookback historical timestamps. For example, the data can be formatted as pandas DataFrames. The DataFrames are widely used in data science, machine learning, scientific computing, and many other data-intensive fields. The disclosed system can incorporate the temporal significance of the datasets and creates a list of DataFrame each containing a set of sequentially correlated samples i.e., with the same periods (the lookback sequence). The data can be imported as multiple DataFrames, wherein each DataFrame contains a chronological sequence that is independent of the other sequences. It may ensure that each independent chronological sequence has no effect on any other chronological sequence in the imported data. The disclosed system can be characterized as being multivariate data management friendly.

The imported data can be previewed on the Preview Tab 6 in which first few samples can be displayed along with some basic information related to the dataset, for example, size, number of samples, frequency, etc. A check can be made if the dataset is correctly formatted at decision box 7. If the dataset is formatted correctly, the data can be used in the next steps. However, if the dataset cannot not correctly formatted, the client or user can edit the dataset at block 8, for example, eliminating a particular column of data or excluding potentially corrupted data from a specific period. In one case, the approval for the dataset may be needed from the user or client to proceed further.

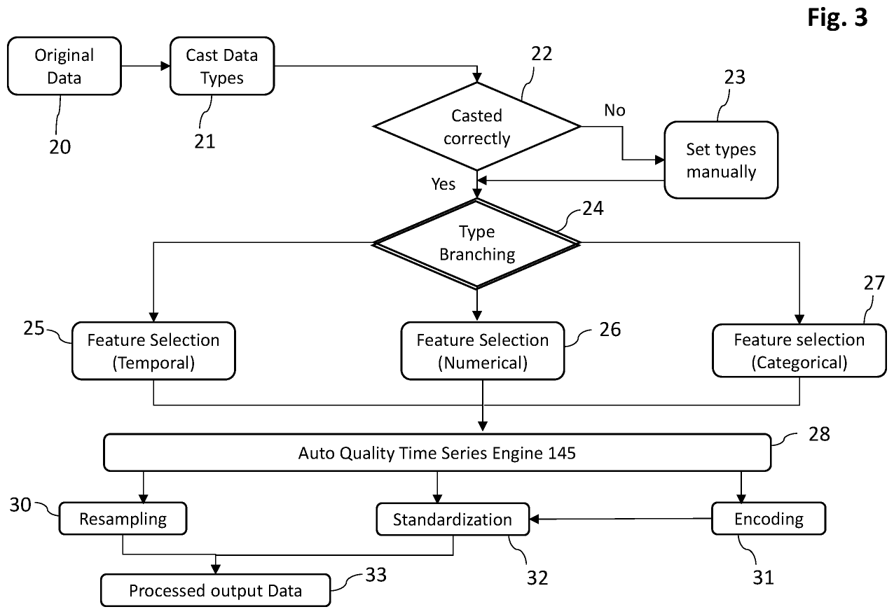

The Pre-processing block 9, also referred to herein as Dynamic Auto Processing Pipeline (DAPP) is shown in FIGS. 1 and 2, and the DAPP process flow is depicted in greater detail in FIG. 3. It is to be noted that in the drawings, when a decision in the flowchart is made automatically by software, the decision point is depicted by being a double-lined diamond shape. When a decision in the flowchart is made by a human, a single-lined diamond shape is used. The Dynamic Auto Processing Pipeline upon execution by the processor can clean and format the dataset to ensure that the model can be trained using the processed and quality output data 33, the data 33 can be clean, denoised, and unbiased data. The DAPP 140 can start with the original data 20 that is received from the data import function 130 and that has approved by the client. The first process of the DAPP is that the data can undergoes type casting 21. Due to the generalized nature of this engine, the engine tries to infer the type of data in each column, in the imported dataset, which can serve as the basis of the consequent processing operations. The types which the DAPP cab infer are timestamps, numerical, and categorical. The clients can have the ability to inspect the types casted and determine whether or not they are casted correctly, and a decision can be made at the decision box 22. If not, then the clients can set the types manually 23 before proceeding to Type Branching 24. Feature Selection: dimensionality in statistics refers to how many attributes a dataset has. For example, data like machine name, date, time, sensor reading, and so on are attributes. While classification or clustering the data, it must be decided which of all the dimensions could be used to get meaningful information. The “curse of dimensionality” is a challenge faced by every machine learning application. Removing unnecessary information from the dataset increases the data processing speed, reduces the time required to train the model, and improves the performance. Performance improvement is because uninformative columns of data would create additional noise during training. This is done using information relating to the variance of the data, autocorrelation functions, and other parametric attributes used in the time series analysis. The feature selection methods can differ between temporal features 25, numerical features 26, and categorical features 27. For example, categorical features that are entirely unique are counterproductive to be included in the model. However, numerical features rarely have duplicate values, which requires the utilization of variance correlation and autocorrelation to determine its usefulness.

After Feature Selection, the multivariate time series features can be fed into the Auto Quality Time Series Engine 145 (auto quality pre-processing) which is another AI deep learning model that takes the role of automatically denoising the time series data by learning its normal patterns as well as detecting the abnormal ones like missing sensor values or signal spikes, then autofill the abnormal parts with a normal series. So, the output signals can be fed into the PIMMT function 150 and get the best possible results.

While the sequence of steps described above is a preferred embodiment of this invention, specifically, the order of operation to optimize for maximum efficiency and low overhead cost, other orders of operation of the same steps or a reduced number of steps may also be used to achieve similar results based on changing the optimization trade-off between efficiency and overhead, and such alternate sequences are also contemplated by this invention which is the subject of this patent.

Resampling 30: Handling time series data comes with added complexity as timestamps must be processed and cannot be arbitrarily dropped. If the task specified by the client is forecasting, then the dataset will be modified so that the frequency of the timestamps can be a fixed constant. Then, the data can be resampled based on the fixed frequency of the time stamps. However, with classification and regression tasks, timestamps will be processed, and a new feature will be created based on the information retrieved from them. For example, the variable sampling period is calculated and used as a scaling factor to determine future predictions. The variable sampling period refers to the time delta (temporal difference) between two consecutive samples.

Encoding 31: Columns deemed to be categorical are encoded into numerical features.

The implementation of an encoding method is highly dependent on the attributes of the categorical features, such as the number of categories and whether the data is ordinal. These implementations include one-hot encoding, label encoding and gaussian target encoding.

Standardization 32: To avoid hidden biases in the model, the numerical features will be standardized and normalized. An appropriate standardization method will be used depending on the distribution of the features. For example, z-score standardization can be implemented for features following a normal distribution.

Again, referring to FIG. 2, the processed data and descriptive statistics about it can be displayed on the visualization tab 10 along with analytics figures that give insight about the data at hand. For example, some of the descriptive statistics may include the parameters of mean value, standard deviation, range, upper and lower control limits, number of samples in the dataset, the NaN value percentage, and feature wide autocorrelation function. (The model training settings are established in the Configure Training Setting block 11. The client can specify high level hyper parameters such as duration of training, but additional fine tuning is also possible. For example, settings that are established in this block may include learning method, learning rate, optimizer, regularization factor, etc.

Model Building (PIMMT) 12: To train disclosed model generated by the disclosed system 100, one or several deep learning algorithms are used. These algorithms may be based on the implementation of Long Short Term Memory (LSTM) nodes in a library framework, such as Keras, which is a known open source software library that provides a Python interface for artificial neural networks, or they may be based on other consequential models such as Hidden Markov Model (HMM) or incorporate classic machine learning models such as the Autoregressive Integrated Moving Average (ARIMA) family. Once the pre-processing step (DAPP) 9 could be completed, the data can be used in the models in the Parallelized Intelligent Multi Model Training (PIMMT) function 12 to train 12a these models simultaneously in a parallel manner. This method takes advantage of the distributed systems used in cluster computing services, which makes the training of these models significantly faster. After training 12a, the model will then be evaluated by measuring its performance 12b. The performance parameters that are evaluated include accuracy, precision, recall, f1-score, specificity, sensitivity mean square error (MSE), root mean square error (RMSE), mean absolute error (MAE), symmetric mean absolute percentage error (SMAPE), etc. All are known in the art as machine learning performance metrics. The Accuracy refers to the number of correct predictions/total number of predictions. The Precision (also called positive predictive value) is the fraction of relevant instances among the retrieved instances. Recall (also known as sensitivity) is the fraction of relevant instances that were retrieved. Specificity is the measure of the proportion of True Negatives Vs Sum of Predicted False Positives and Predicted True Negatives. Mean Absolute Error MAE is the absolute difference between the actual or true values and the values that are predicted=True values−Predicted values. Mean Squared Error (MSE) is average of the square of the difference between the original and predicted values of the data. Root Mean Squared Error (RMSE) is the standard deviation of the errors which occur when a prediction is made on a dataset.

The specific metric can be set by the client in the fine-tune window to optimize the training for the needed task. The PIMMT module can determine whether the model has reached best results at the decision box 12c based upon the output of the measured performance relative to a set of criteria. At that point the model will be modified by having its hyper-parameters 12d and retrained, or a decision can be made to Deploy the Model in the decision box 13 and use it in prediction. The hyper-parameters can be those parameters which values are used to control the learning process based on the best metrics mentioned above.

Deployment: Once a trained model is deployed through the deployment function 15, it can be accessed via the prediction tab 16 of FIG. 1.

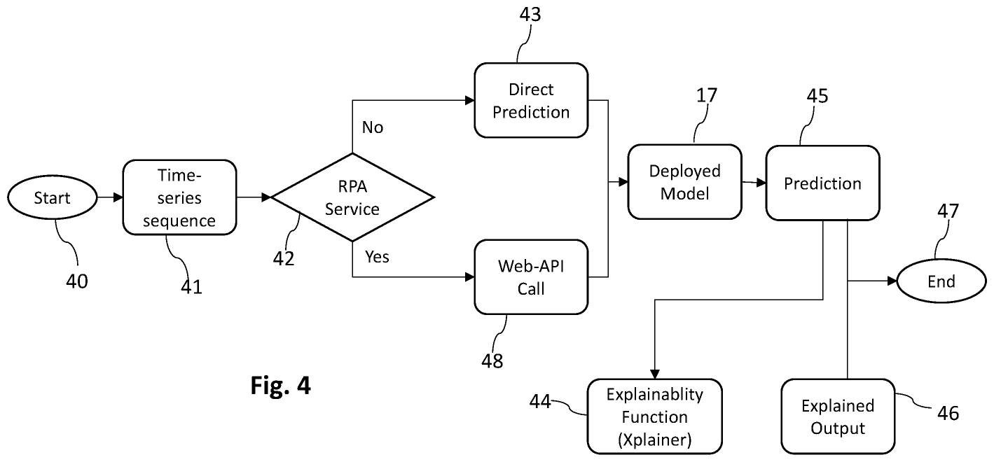

FIG. 4 illustrates how an AI model created by this disclosed system is deployed and used in practice. As shown in FIG. 4, the process starts 40 with a time-series sequence data input 41 to feed into the generated model. The user can decide to use or not use a Robotic Process Automation (RPA) service 42. If an RPA service is used, a Web-API call 48 can be initiated, and if the RPA service is not used, a Direct Prediction 43 can be made. The data can be fed into the deployed model 17.

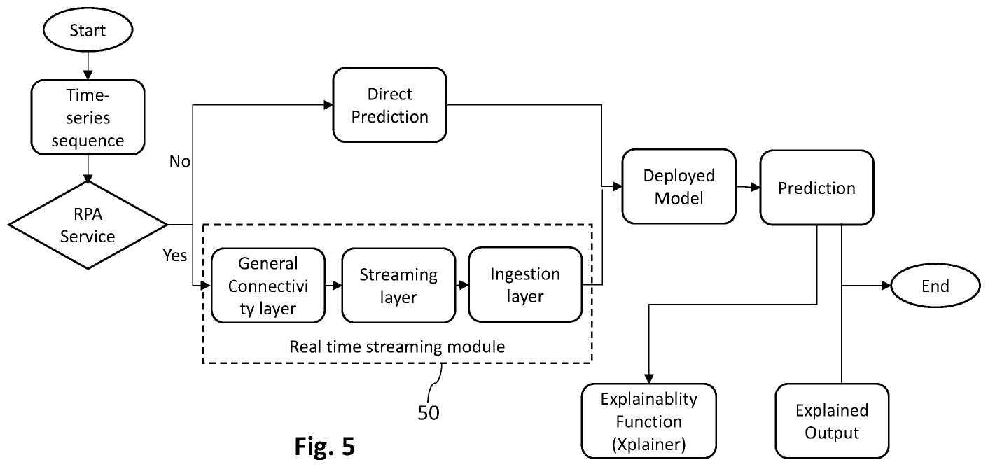

The deployed model generates a prediction output 45. Each prediction (output) 45 is compared to the Time-Series Sequence data input 41 by the explainability function, the XPlainer 44, also known as XReason. It is a proprietary method for each auto generated model, so is auto generated with each model to explain why it predict that way. The XPlainer module can deliver Explained Output 46 which infers the most significant input features in terms of their contribution to the output. The XPlainer enables clients to identify and analyze aspects or abnormalities that caused the model to make the predictions that it made. The XPlainer is differentiated from prior explainability functions because it has dynamic evaluation parameters. For example, some typical explainability functions might set a threshold that NaN values should be less than 30% of the total. But the AI aspects of this dynamic explainability function, the XPlainer, set the threshold based on analysis of the variation of the non-NaN data. The XPlainer function provides a window into the inner workings of the AI model, thus enabling the TSG to be a “glass box” system as opposed to a typical black box deep learning model. Also, referring to FIG. 5 which shows the embodiment of generating the prediction similar to the embodiment illustrated in FIG. 4 except the Web-API call 48 is replaced by a real time streaming module 50.

The major benefits and advantages of the TSG Engine that is the subject of this invention compared to the prior art include the following:

No code or block functions needed: Unlike some libraries that automate the testing of machine learning models, for example, AutoML and AutoTS, the TSG engine which is the subject of this invention requires no coding and can be intuitively used by domain experts of nearly any discipline. While some drag and drop frameworks for building data science applications, for example, knime.com, provide blocks or nodes to create a flow for data analytics, that approach requires the users to have an in-depth understanding of each of the nodes and their interconnections which results in a steep learning curve.

Intuitive UI: To allow clients of various backgrounds to use this engine, an intuitive and simple UI was designed which requires only a minimum number of inputs from the client. Other inputs are inferred by the TSG Engine. The visualization capabilities of this TSG Engine can be easily interpreted by people who have no formal data science training. The XPlaine explainability function increases the client's or user's understanding of the data being evaluated by associating a weighted value that corresponds to the contribution of the input to the final prediction. This allows clients to find hidden correlations and diagnose the system proactively rather than undergoing a retrospective analysis of a failure reactively.

Descriptive Predictive Modeling (DPM): Some existing deep learning model engines, for example, “abacus.ai” and “datarobot.com”, can build predictive deep and machine learning models, but not simultaneously build descriptive machine learning models. The invention which is the subject of this patent application can do both. The descriptive aspects of data science can be equally as informative as the predictive aspects which is why the TSG Engine which is the subject of this invention provides descriptive statistics for the imported dataset as well as figures of meaningful properties in the dataset. This TSG engine uniquely provides both predictive and descriptive outputs in the same module. This TSG engine provides both predictions and analytics to better understand the data.

Integration to robotic process automation (RPA) services: To simplify operations further, the TSG Engine is designed to easily integrate with common industry tools such as RPA services with no human involvement. It can be easily integrated using predefined activities, allowing the APIs to be called by a suite of various commercially available applications ranging from Excel to Power BI.

Real Time Streaming Module: all-time series application should be integrated with real time sensors so a full general module is built to easily integrate with real time data that can be from sensor devices, time series databases or from automation control systems

The Real Time Streaming Module is consist of three layers; the general connectivity layer that can connect with any device or server using multiple protocols like Modbus, MQTT, HTTP, or OPC-UA and then the streaming layer that consists of a broker module to publish the streamed data to and finally the ingestion layer that contains the ingestion service that integrates and aggregates the streamed data to shape the data in the form the model can predict. With this module any real time prediction, forecasting or classification can be done after a time series deep learning model is generated using the GTS engine easily.

The value of this TSG engine method and system rests within the sum of its parts, because it is a holistic end-to-end process that simplifies time series-based data science projects allowing clients to analyze their datasets, to quickly create predictive AI models, and to rapidly deploy these AI models and generate a positive return on investment.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

Therefore, the scope of the invention is not intended to be limited to the various aspects and embodiments discussed and described herein. Rather, the scope and spirit of invention is embodied by the appended claims.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A system for automating a process of creating an artificial intelligence time series model, the system comprising a processor and a memory, the system configured to implement a method comprising the steps of:
importing, by a data import function implemented within the system and upon processing by the processor, a time-series dataset;
formatting, by a dynamic auto processing pipeline function implemented within the system and upon processing by the processor, of the time series dataset;
upon formatting, training, simultaneously and in parallel, a plurality of machine learning models, by a parallelized intelligent multi model training function implemented within the system and upon processing by the processor;
upon training, evaluating, by the parallelized intelligent multi model training function, the plurality of machine learning models using a plurality of performance parameters; and
deploying, by a deployment function implemented within the system and upon processing by the processor, a trained model of the plurality of machine learning models.

2. The system according to claim 1, wherein the time-series dataset is imported as multiple DataFrames, wherein each DataFrame of the multiple DataFrames contains a chronological sequence, wherein the chronological sequence of each of the multiple DataFrames is different.

3. The system according to claim 1, wherein the step of formatting comprises typecasting the time series dataset, wherein the dynamic auto processing pipeline function infers a type of data for each column of the time series dataset, wherein the type of data is selected from a group consisting of temporal, numerical, and categorical.

4. The system according to claim 1, wherein the plurality of machine learning models comprises deep learning models.

5. The system according to claim 4, wherein the plurality of machine learning models comprises Long Short Term Memory (LSTM) models, Hidden Markov Model (HMM), and Autoregressive Integrated Moving Average (ARIMA) models.

6. The system according to claim 3, wherein the method further comprises the steps of:
modifying a temporal data of the time-series dataset so that a frequency of timestamps is a fixed constant; and
resampling the temporal data on a fixed frequency of the timestamps.

7. The system according to claim 6, wherein the method further comprises the steps of:
encoding categorical data of the time-series dataset into numerical features.

8. The system according to claim 7, wherein the method further comprises the steps of:
normalization and standardization of numerical data of the time-series dataset.

9. The system according to claim 1, wherein the plurality of performance parameters are selected from a group consisting of accuracy, precision, recall, F1-score, specificity, sensitivity mean square error (MSE), root mean square error (RMSE), mean absolute error (MAE), and symmetric mean absolute percentage error (SMAPE).

10. A method for automating a process of creating an AI model, the method implemented within a system comprising a processor and a memory, the method comprising the steps of:
importing, by a data import function implemented within the system and upon processing by the processor, a time-series dataset;
formatting, by a dynamic auto processing pipeline function implemented within the system and upon processing by the processor, of the time series dataset;
upon formatting, training, simultaneously and in parallel, plurality of machine learning models, by a parallelized intelligent multi model training function implemented within the system and upon processing by the processor;
upon training, evaluating, by the parallelized intelligent multi model training function, the plurality of machine learning models using a plurality of performance parameters; and
deploying, by a deployment function implemented within the system and upon processing by the processor, a trained model of the plurality of machine learning models.

11. The method according to claim 10, wherein the time-series dataset is imported as multiple DataFrames, wherein each DataFrame of the multiple DataFrames contains a chronological sequence, wherein the chronological sequence of each of the multiple DataFrames is different.

12. The method according to claim 10, wherein the step of formatting comprises typecasting the time series dataset, wherein the dynamic auto processing pipeline function infers a type of data for each column of the time series dataset, wherein the type of data is selected from a group consisting of temporal, numerical, and categorical.

13. The method according to claim 10, wherein the plurality of machine learning models comprises deep learning models.

14. The method according to claim 13, wherein the plurality of machine learning models comprises Long Short Term Memory (LSTM) models, Hidden Markov Model (HMM), and Autoregressive Integrated Moving Average (ARIMA) models.

15. The method according to claim 12, wherein the method further comprises the steps of:
modifying a temporal data of the time-series dataset so that a frequency of timestamps is a fixed constant; and
resampling the temporal data on a fixed frequency of the timestamps.

16. The method according to claim 15, wherein the method further comprises the steps of:
encoding categorical data of the time-series dataset into numerical features.

17. The method according to claim 16, wherein the method further comprises the steps of:
normalization and standardization of numerical data of the time-series dataset.

18. The method according to claim 10, wherein the plurality of performance parameters are selected from a group consisting of accuracy, precision, recall, F1-score, specificity, sensitivity mean square error (MSE), root mean square error (RMSE), mean absolute error (MAE), and symmetric mean absolute percentage error (SMAPE).

19. The method according to claim 10, wherein the method further comprises the steps of:
determining prediction, forecasting or classification, using the trained model, by a real time streaming module implemented within the system and upon processing by the processor.

20. The method according to claim 12, wherein the method further comprises the steps of:
upon typecasting the time series dataset, denoising the time series dataset, by a machine learning based auto quality time series engine implemented within the system and upon processing by the processor, wherein the auto quality time series engine is configured to determine normal patterns and abnormal patterns.
